(19) United States
(12) Patent Application Publication
(10) Pub. No.: US 2007/0279192 A1
(43) Pub. Date: Dec. 6, 2007

(54) RFID communication control method and RFID system using same

(76) Inventor: Yoshinori Tanaka, Kawasaki (JP)

Correspondence Address: BINGHAM MCCUTCHEN LLP, 2020 K Street, N.W., Intellectual Property Department, WASHINGTON, DC, 20006, US

(21) Appl. No.: 11/878,398

(22) Filed: Jul. 24, 2007

Related U.S. Application Data
(63) Continuation of application No. PCT/JP05/01320, filed on Jan. 31, 2005.

(51) Int. Cl. H04Q 5/22

(52) U.S. Cl. 340/10.2; 340/572.7; 340/10.1; 340/10.3; 343/756

(57) ABSTRACT

An RFID system, which increases the probability of detection of an unused channel and which can reduce the effect of interference between reader/writers, has a reader/writer which has a reader/writer main unit and a polarization-switchable antenna and which transmits a continuous carrier wave, and a tag which modulates the continuous carrier wave with tag information and returns a response signal to the reader/writer; the reader/writer main unit judges the level of a received interference signal, determines a polarization direction for which the level of the interference signal is equal to or less than a threshold, transmits a command signal to the tag with a polarization direction different from the polarization direction thus determined, and receives a response signal from the tag to the command signal with the polarization direction thus determined.

### CROSS-REFERENCE TO RELATED APPLICATIONS

This application is a continuation of international application PCT/JP2005/001320, filed on Jan. 31, 2005.

### FIELD OF THE INVENTION

This invention relates to a radio frequency ID (RFID) carrier sensing method, and to an RFID reader/writer and RFID system using the method.

### BACKGROUND ART

In recent years, systems which utilize electromagnetic coupling with tags to perform reading of ID information recorded in a tag, and RFID systems which use radio frequencies to read tag information, have been developed and used.

As an example of the latter RFID systems which use radio frequencies to perform reading, the European Telecommunications Standards Institute (ETSI) has prepared European standards (Draft ETSI EN 302 208-1V1.1.1 (2003-12)). In this Draft ETSI EN 302 208-1V1.1.1 (2003-12), use of RFID systems employing power of up to a maximum 2 W in the 865 MHz to 868 MHz frequency band has been proposed.

There are cases in which, in an RFID system, a plurality of reader/writers are operated in proximity. FIG. 1 is a diagram explaining an example of such a state.

In FIG. 1, signals transmitted by the respective reader/writers #1 (#2) become interference 3 with the other reader/writer #2 (#1), and so there is the problem that the reception performance of the reader/writers #1, #2 is degraded. In order to address this problem, carrier sensing is performed prior to transmission in order to reduce the effect of interference 3, and a search is performed for a frequency channel not used by the other reader/writer #2 (#1). A method is adopted in which, if an unused channel is present, the channel is used, and if not present, the device waits until an unused channel is found.

FIG. 2 explains this method employing carrier sensing, and shows the flow of an operation to read tag information in each of the reader/writers in FIG. 1.

According to the flow of FIG. 2, each of the reader/writers #1, #2 comprises a reader/writer main unit 1a and an antenna 1b.

First, an initial channel (frequency band) is set in the reader/writer main unit 1a (step S1), and the level of the carrier received by the antenna 1b in this preset initial channel is measured as an interference signal (step S2). If the interference signal level is equal to or greater than a threshold value (“N” in step S3), this channel cannot be used, and so the interference level in another channel is measured. That is, a judgment is made as to whether measurements have been performed for all channels, and if there are channels which have not been measured (“N” in step S4), reception is switched to the next channel (step S5), and processing returns to similar interference level measurements (step S2).

When measurement of all channels has already been performed (“Y” in step S4), a random wait time is set (step S6), and after the preset wait time has elapsed, processing returns to the initial channel setting (step S1), and the above processing is repeated.

In the above interference level measurement (step S2), if the interference level is equal to or less than the threshold value (“Y” in step S3), the channel for which the interference level is equal to or less than the threshold value is selected (step S7), and command signals are transmitted (step S8).

FIG. 3 explains the command signal radiated from the antenna 1b of the reader/writer #1 (#2) and the response signal from the tag 2a (2b). As shown in FIG. 3A, the reader/writers #1, #2 transmit an unmodulated continuous wave CW, and this unmodulated continuous wave CW is modulated by command signals and is transmitted from the antenna 1b with, for example, a fixed right-circular polarization.

When the tags 2a, 2b receive command signals from the corresponding reader/writers #1, #2, characteristic information comprising identification information (ID) for the article to which the tag is attached is used as tag information to modulate the unmodulated continuous wave CW in response (step S9; see FIG. 3B). Upon receiving this response signal, the reader/writers #1, #2 end communication (step S10).

As a separate method, a method may be employed in which a control device executes central control of a plurality of reader/writers #1, #2, to control the transmission timing of the respective reader/writers.

Further, in U.S. Pat. No. 6,255,993B1, an invention is disclosed relating to a system to perform transmission and reception of interrogation signals and response signals between an interrogator and a transponding module. As a characteristic disclosed, when a single antenna for both transmission and reception in the same frequency band is used, or when two antennas positioned in proximity and respectively performing transmission and reception are used, there is the problem that transmission signals which are the interrogator signals return directly to the receiver antenna, and have an effect on the reception quality of received signals; in order to avoid this problem, the antenna polarization direction is made different at the time of transmission of interrogator signals and at the time of reception of response signals.

As described above, in the former method, in which with a plurality of reader/writers are operated in proximity, carrier sensing is performed to search for a frequency channel not used by another reader/writer, and when an unused channel is found the channel is used, as in the flow of FIG. 2, there is the problem that the wait time becomes long when there are numerous reader/writers. And in the latter method employing central control by a control device, there is the problem that when there are numerous reader/writers, the allocated communication time is short.

Further, in the invention disclosed in U.S. Pat. No. 6,255,993B1, a case in which a plurality of reader/writers exist is not assumed, and a single frequency band (channel) is always used, and there is no description of application to a system in which searches for an unused channel among a plurality of channels are performed.

### DISCLOSURE OF THE INVENTION

Hence an object of this invention is to provide an RFID communication control method, in an RFID system in which there exist a plurality of reader/writers, in which the problems of a long transmission timing wait time for the respective reader/writers, or of a short allocated communication time, are eliminated, and the effect of mutual interference occurring when a plurality of reader/writers are in proximity can be reduced.

A further object of this invention is to provide an RFID reader/writer and an RFID system which utilize this RFID communication control method.

A first aspect of an RFID system which attains the above objects has a reader/writer, which has a reader/writer main unit and a polarization-switchable antenna and which transmits a continuous carrier wave, and a tag which modulates the continuous carrier wave with tag information and returns the response signal to the reader/writer, and is characterized in that the reader/writer main unit judges the level of a received interference signal and determines a polarization direction for which the level of the interference signal is equal to or less than a threshold value, transmits a command signal to the tag with a polarization direction different from the polarization direction thus determined, and receives the response signal from the tag to the command signal with the polarization direction thus determined.

A second aspect of an RFID system which attains the above objects is the first aspect, characterized in that the polarization-switchable antenna can be switched between right-circular polarization and left-circular polarization.

A third aspect of an RFID system which attains the above objects is the first aspect, characterized in that the polarization-switchable antenna can be switched between horizontal polarization and vertical polarization.

A fourth aspect of an RFID system which attains the above objects is the first aspect, characterized in that the reader/writer main unit judges the level of the interference signals received in each of a plurality of channels, and determines a polarization direction for which the interference signal level is equal to or less than the threshold value.

A fifth aspect of an RFID system which attains the above objects has a reader/writer, which has a reader/writer main unit and a plurality of antennas each having a specific polarization and which transmits a continuous carrier wave, and a tag which modulates the continuous carrier wave with tag information and returns the response signal to the reader/writer, and is characterized in that the reader/writer main unit judges the levels of interference signals received by each of the plurality of antennas and determines an antenna for which the polarization is such that the level of the judged interference signal is equal to or less than a threshold value, transmits a command signal from an antenna other than the antenna with the polarization thus determined, and receives the response signal to the command signal from the antenna with the polarization direction thus determined.

A first aspect of an RFID communication control method which attains the above objects is an RFID communication control method in an RFID system, having a reader/writer which has a reader/writer main unit and a polarization-switchable antenna and which transmits a continuous carrier wave, and a tag which modulates the continuous carrier wave with tag information and returns the response signal to the reader/writer, and is characterized in that, in the reader/writer, control is executed such that the interference signal level is measured for a specific channel in succession for all switchable polarizations of the antenna, and when the measured interference signal level is equal to or greater than a threshold value, the specific channel is switched to a different channel and the interference signal is measured, a channel and polarization direction for which the measured interference signal level does not exceed the threshold value are determined, a command signal is sent to the tag with a polarization direction other than the polarization direction thus determined, and a response signal to the command signal is received in the channel and with the polarization direction thus determined.

A second aspect of an RFID communication control method which attains the above objects is an RFID communication control method in an RFID system, having a reader/writer which has a reader/writer main unit and a plurality of antennas each set to different polarization directions and which transmits a continuous carrier wave, and a tag which modulates the continuous carrier wave with tag information and returns the response signal to the reader/writer, and is characterized in that, in the reader/writer, control is executed such that the interference signal level is measured for a specific channel in succession for each of the polarizations of the plurality of antennas, and when the measured interference signal level is equal to or greater than a threshold value, the specific channel is switched to a different channel and the interference signal is measured, a channel and an antenna set to a polarization direction for which the measured interference signal level does not exceed the threshold value are determined, a command signal is sent to the tag from an antenna other than the antenna with the polarization direction thus determined, and a response signal to the command signal is received in the channel and by the antenna with the polarization thus determined.

A first aspect of a reader/writer in an RFID system which attains the above objects is a reader/writer in an RFID system having a reader/writer main unit and a polarization-switchable antenna, and which transmits a continuous carrier wave to a tag, and is characterized in that the level of a received interference signal is judged and a channel and polarization direction of the antenna for which the level of the interference signal is equal to or less than a threshold value are determined, a command signal is transmitted to the tag with a polarization direction different from the polarization direction thus determined, and the response signal to the command signal, generated by modulating the continuous carrier wave with tag information and returned from the tag, is received with the channel and polarization direction thus determined.

A second aspect of a reader/writer in an RFID system which attains the above objects is a reader/writer in an RFID system having a reader/writer main unit and a plurality of antennas each set to different polarization directions and which transmits a continuous carrier wave to a tag, and is characterized in that the reader/writer main unit judges the level of a received interference signal from each of the plurality of antennas for each of a plurality of channels, determines a channel and antenna for which the judged level of the interference signal is equal to or less than a threshold value, transmits a command signal to the tag from an antenna other than the antenna thus determined, and receives the response signal to the command signal, generated by modulating the continuous carrier wave with tag information and returned from the tag, in the channel thus determined and with the antenna thus determined.

A third aspect of a reader/writer in an RFID system which attains the above objects is a reader/writer in an RFID system having a reader/writer main unit and two dipole antennas having horizontal and perpendicular polarization directions and which transmits a continuous carrier wave to a tag, and further having a transmission/reception switch, and is characterized in that the reader/writer main unit judges the level of received interference signals with horizontal and with perpendicular polarization for each of a plurality of channels, and determines a channel and either horizontal or perpendicular polarization for which the judged level of the interference signal is equal to or less than a threshold value; the transmission/reception switch performs switching control, according to a switching signal based on the determination by the reader/writer main unit, to output a command signal output from the reader/writer main unit to the dipole antenna not corresponding to the horizontal or perpendicular polarization thus determined, and conversely, to input a response signal, returned from the tag and received by the dipole antenna corresponding to the horizontal or perpendicular polarization thus determined, to the reader/writer main unit.

Other characteristics of the invention will become clearer from the explanation of the preferred aspects of the invention which follows, referring to the drawings.

By means of this invention, the probability of detection of an unused channel can be increased, and the effect of interference between reader/writers can be reduced.

### BRIEF DESCRIPTION OF THE DRAWINGS

FIG. 1 explains an example of the state of an RFID system in which a plurality of reader/writers are operating in proximity;

FIG. 2 explains a method of unused channel detection by carrier sensing;

FIG. 3 explains command signals radiated from the antenna 1b of a reader/writer #1 (#2) and response signals from a tag 2a (2b);

FIG. 4 explains characteristics of this invention in a case of an RFID system in which a plurality of reader/writers #1, #2 are operating in proximity;

FIG. 5 is a conceptual diagram of an example of the configuration of a reader/writer to which this invention is applied;

FIG. 6 is another conceptual diagram of an example of the configuration of a reader/writer;

FIG. 7 is a conceptual block diagram of a embodiment of a tag 2a (2b);

FIG. 8 shows the flow of operation in one embodiment of the invention;

FIG. 9 explains command signals radiated the antenna 1b of a reader/writer #1 (#2) and response signals from a tag 2a (2b);

FIG. 10 shows the relation between channels Ch1 to Ch4 and polarization directions 1 to n, determined by the flow of the embodiment of FIG. 8;

FIG. 11 shows an embodiment in which a plurality of antennas, with a specific polarization direction set for each, are used;

FIG. 12 is a conceptual diagram of another example of the configuration of a reader/writer to which this invention is applied;

FIG. 13 explains control of the switches SW1 to SW4 in FIG. 12; and

FIG. 14 shows the flow of operation in another embodiment of this invention, using the reader/writer shown in FIG. 12.

### PREFERRED EMBODIMENTS OF THE INVENTION

Embodiments of the invention are explained below, referring to the drawings. The aspects explained below are intended to facilitate an understanding of the invention, but the technical scope of the invention is not limited to these aspects.

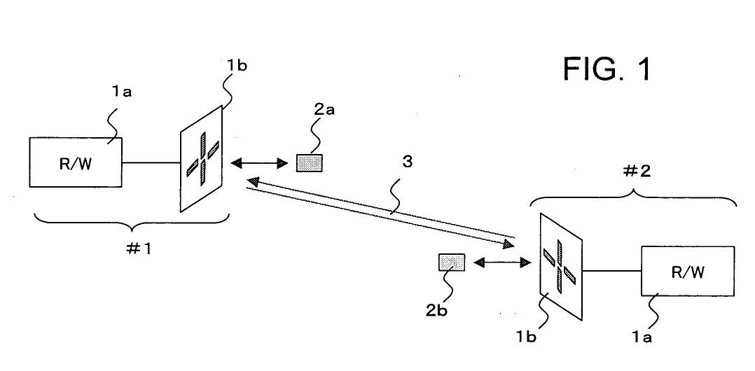

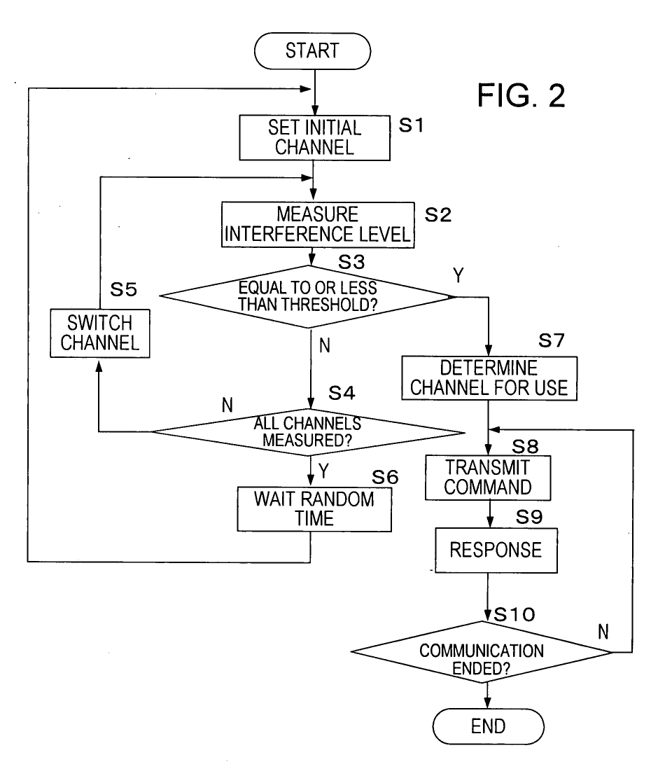

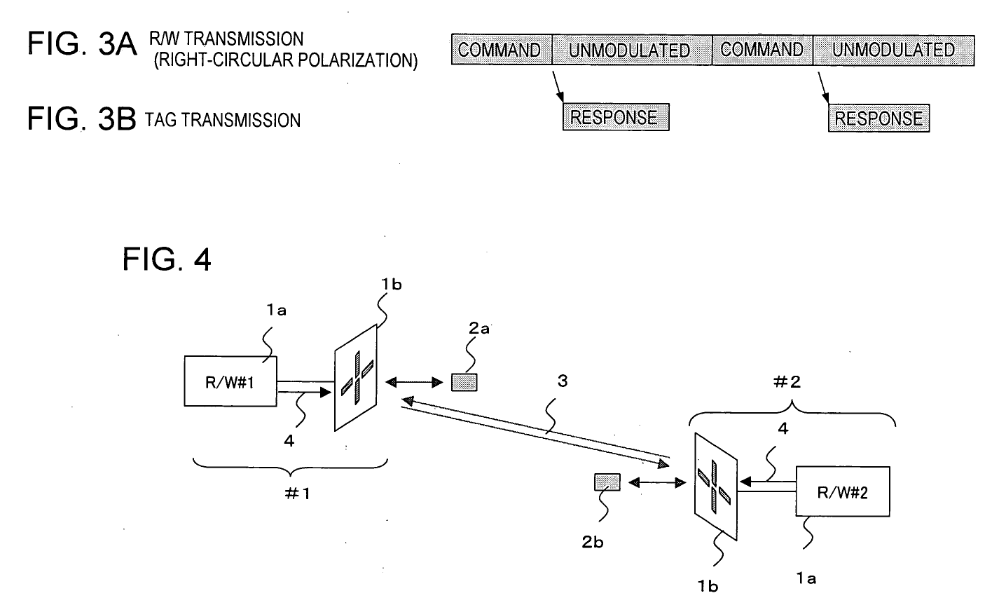

FIG. 4 shows a case of an RFID system in which a plurality of reader/writers #1, #2 are operating in proximity. In contrast with FIG. 1, as a characteristic of RFID communication control of this invention, a function 4 is provided to control the polarization direction of the reader/writer antennas 1b after carrier sensing.

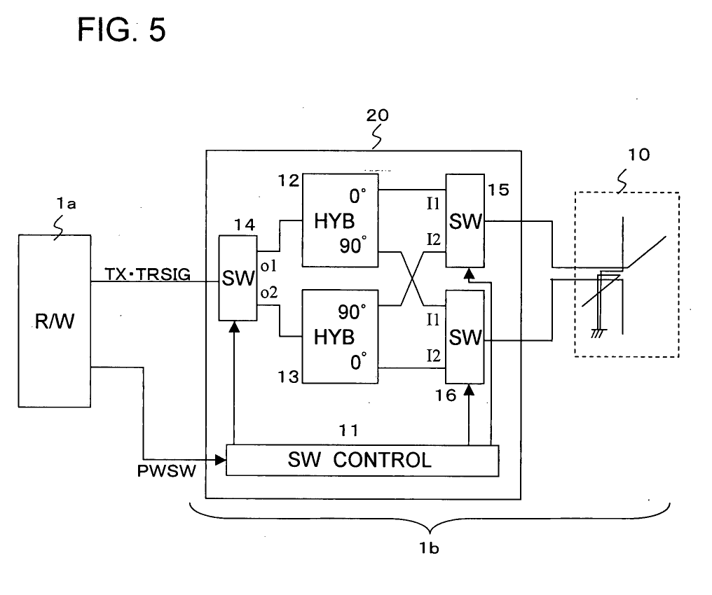

FIG. 5 is a conceptual diagram showing an example of the configuration of reader/writers #1, #2 to which this invention is applied. In FIG. 5, the antenna 1b has an antenna element 10 and a polarization direction control portion 20. The polarization direction control portion 20 has, as its characteristic, a function for controlling switching of the polarization direction of the antenna element 10 between right-circular polarization and left-circular polarization.

The antenna element 10 comprises two orthogonal dipole antennas; the horizontal-direction dipole antenna is connected to the switch 15, and the vertical-direction dipole antenna is connected to the switch 16.

The reader/writer main unit 1a sends a transmission signal TXSIG to the switch 14 of the polarization direction control portion 20, and inputs a reception signal TRSIG from the switch 14. The reader/writer main unit 1a also sends a polarization-switching signal PWSW to the switch control portion 11 of the polarization direction control portion 20.

Each of the two hybrid circuits 12, 13 inputs the transmission signal TXSIG, and outputs signals phase-shifted by 0° and 90°. The switch control portion 11 controls the switches 14, 15, 16 according to the polarization switching signal PWSW from the reader/writer main unit 1a.

That is, when a polarization switching signal PWSW specifying right-circular polarization is sent from the reader/writer main unit 1a to the switch control portion 11, the switch control portion 11 supplies switching signals to the switches 14, 15, 16 so as to activate the output terminal o1 of the switch 14 and the input terminals I1 to the switches 15, 16.

On the other hand, when a polarization switching signal PWSW specifying left-circular polarization is sent from the reader/writer #1 to the switch control portion 11, the switch control portion 11 supplies switching signals to the switches 14, 15, 16 so as to activate the output terminal o2 of the switch 14 and input terminals 12 of the switches 15, 16.

Hence when an 0° phase-shift signal is supplied from the switch 15 to the horizontal-direction dipole antenna element of the antenna element 10, and a 90° phase-shift signal is supplied from the switch 16 to the vertical-direction dipole antenna element of the antenna element 10, right-circular polarization results. On the other hand, when a 90° phase-shift signal is supplied from the switch 15 to the horizontal-direction dipole antenna element of the antenna element 10, and an 0° phase-shift signal is supplied from the switch 16 to the vertical-direction dipole antenna element of the antenna element 10, left-circular polarization results.

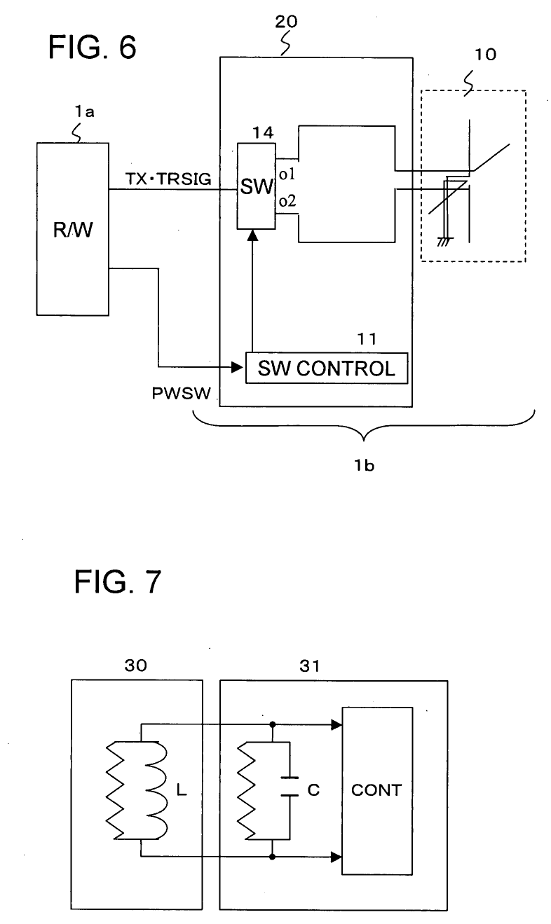

FIG. 6 is another conceptual diagram of an example of the configuration of a reader/writer, having a function to control switching the polarization direction of the antenna element 10 between horizontal polarization and vertical polarization.

In FIG. 6, similarly to the embodiment of FIG. 5, the antenna 1b has an antenna element 10 and a polarization direction control portion 20. The reader/writer main unit 1a sends a transmission signal TXSIG to the switch 14 of the polarization direction control portion 20, and inputs a received signal TRSIG from the transmission/reception switch 14. The reader/writer main unit 1a further sends horizontal and vertical polarization direction switching signals PWSW to the switch control portion 11 of the polarization direction control portion 20.

When a polarization switching signal PWSW specifying horizontal polarization is sent from the reader/writer main unit 1a to the switch control portion 11, the switch control portion 11 activates the output terminal o1 of the switch 14 and causes signals to be supplied to the horizontal dipole antenna element of the antenna element 10. On the other hand, when a polarization switching signal PWSW specifying vertical polarization is sent from the reader/writer main unit 1a to the switch control portion 11, the switch control portion 11 activates the output terminal o2 of the switch 14 and causes signals to be supplied to the vertical dipole antenna element of the antenna element 10.

Thus in the embodiment shown in FIG. 6, based on the polarization switching signal PWSW from the reader/writer main unit 1a, control can be executed to switch the polarization direction of the antenna element 10 between horizontal polarization and vertical polarization, in a configuration which is simpler than that of FIG. 5.

FIG. 7 is a conceptual block diagram of a embodiment of a tag 2a (2b), comprising an antenna portion 30 and an LSI chip 31. The antenna portion 30 comprises, as an example, a patch antenna, and has as an equivalent circuit an inductance L. The LSI chip 31 has a capacitance component C in the interface portion.

The antenna portion 30 and the interface portion of the LSI chip 31 are connected in parallel. Hence if the inductance L of the antenna portion 30 and the capacitance component C of the interface portion are in a resonance relationship, then the continuous wave CW sent from the reader/writer can be received and can be supplied, at maximum power, to the control portion CONT of the LSI chip 31.

The control portion CONT of the LSI chip 31 can use the supplied power to modulate the continuous wave CW with stored characteristic information comprising identification information for the article to which the tag is attached, and can send this wave toward the reader/writer from the antenna portion 30 with a fixed polarization direction (for example, horizontal polarization).

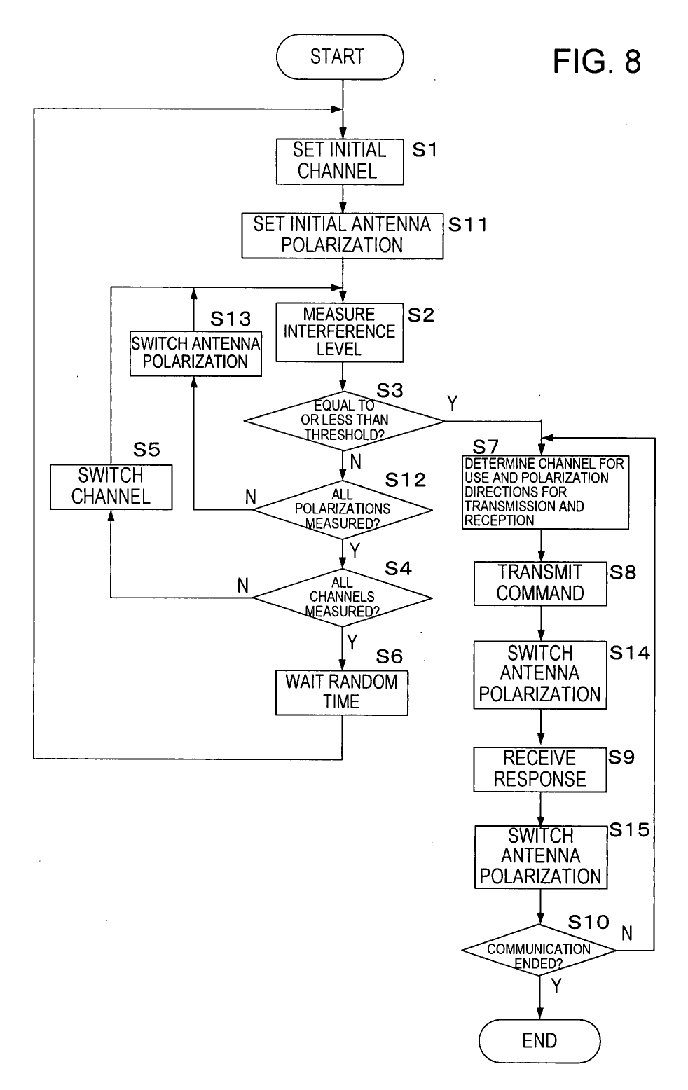

The flow of operation of one embodiment of the invention is explained referring to FIG. 8, assuming such a reader/writer and tag configuration.

In FIG. 8, first the reader/writer main unit 1a sets the initial channel (frequency band) (step S1), and sets the initial antenna polarization (step S11). If the initial antenna polarization is right-circular polarization, then as explained above, in the embodiment of FIG. 5 the switch control portion 11 activates the output terminal o1 of the switch 14 and activates the 0° phase-shift output terminal of the hybrid circuit 12 and input terminal I1 of switch 15. At the same time, the 90° phase-shift output terminal of the hybrid circuit 12 and input terminal I1 of switch 16 are activated.

With these settings made, the level of the carrier received by the antenna element 10 is measured as the interference signal (step S2). If the interference signal level is equal to or greater than a threshold value (“N” in step S3), the channel cannot be used.

At this time, instead of changing the channel, a judgment that there exists a polarization direction for which measurements have not been performed (in this case, the left-circular polarization direction) (step S12), and switching of the antenna polarization to left-circular polarization is performed (step S13). Interference level measurements (step S2) and subsequent processing is again continued, for the newly switched polarization direction.

If the level of interference signals is equal to or higher than the threshold even when measurements have been performed for all polarizations (“N” in step S3), interference levels are measured for another channel. That is, a judgment is made as to whether measurements have been performed for all channels, and if there are channels for which measurements have not been performed (“N” in step S4), the channel is changed to the next channel (step S5), and interference level measurements are similarly performed (step S2).

If measurements have already been performed for all channels (“Y” in step S4), a wait time is set randomly (step S6), and after the wait time thus set has elapsed, processing again returns to the initial channel setting (step S1), and the above processing is repeated.

Further, in the above interference level measurements (step S2), if the interference level is equal to or less than the threshold (“Y” in step S3), then the channel and antenna polarization direction are judged to have an interference level at or below the threshold, and the antenna polarization direction to be used in transmission and reception is determined (step S7).

That is, as a characteristic of the invention, a polarization direction other than an antenna polarization direction determined to have an interference level equal to or less than the threshold is used for transmission of commands, and the antenna polarization direction determined to have an interference level equal to or less than the threshold is used for reception of response signals from the tag.

Hence a polarization direction other than the antenna polarization direction determined to have an interference level equal to or less than the threshold is used, so that interference occurs in command transmission, but during reception a polarization direction with a low interference level is used, so that the advantageous result of reduced interference can be obtained, even with respect to interference from reader/writers which do not perform polarization switching.

The command signal is transmitted using the polarization direction thus determined (step S8). Then, after transmitting the command, the antenna polarization is switched to the previously determined polarization direction for reception (step S14).

The response signal from the tag is received using this switched polarization direction. At this time, the polarization direction to which the antenna has been switched for reception has been judged in carrier sensing to have a low interference level, and so the response signal can be received at a satisfactory level.

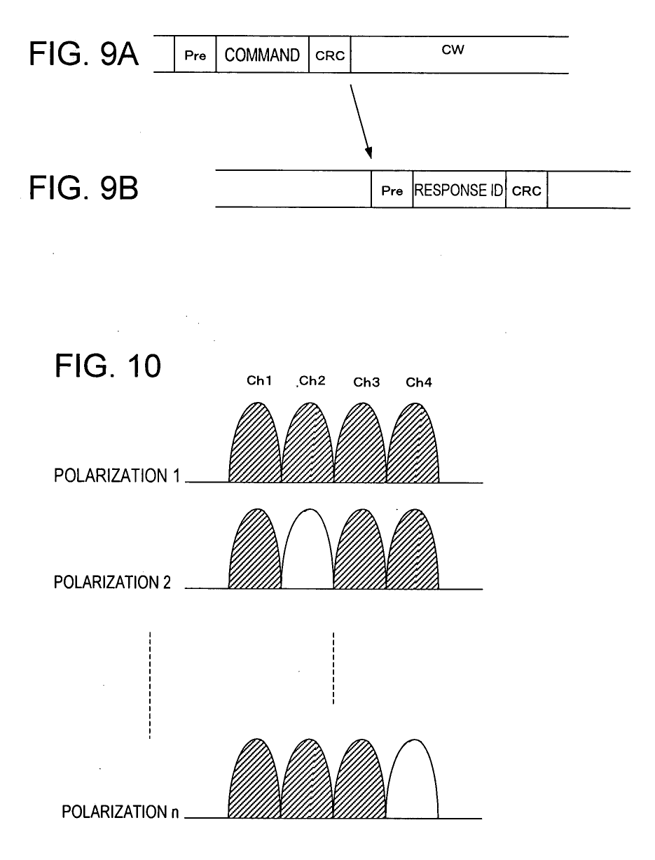

FIG. 9 explains the command signal radiated from the antenna 1b of the reader/writer #1 (#2) and the response signal from the tag 2a (2b).

As shown in FIG. 9A, the reader/writers #1 and #2 use a channel for use and antenna polarization direction determined in advance, using for example right-circular polarization to modulate a continuous wave CW with a frame signal, having a command signal and, before or after the command signal, a preamble Pre and check signal CRC, and transmits the signals.

The tags 2a and 2b receive the command signal from the corresponding reader/writer #1 or #2, and as shown in FIG. 9B, modulate the continuous wave CW with a frame signal, having as tag information characteristic information and identification information for the article to which the tag is attached, and similarly having a preamble Pre and check signal CRC before or after the tag information, and returns the signals to the corresponding reader/writer #1 or #2.

The reader/writer #1 or #2 receives this response signal as a left-circular polarized wave, having switched from the right-circular polarization used at the time of transmission of the command signal in step S14 to left-circular polarization (step S9).

Then, switching is performed to return the antenna polarization to the polarization used for transmission (step S15), and communication ends (step S10).

FIG. 10 shows the relation between channels Ch1 to Ch4 and polarization directions 1 to n, determined by the flow of the embodiment of FIG. 8. In FIG. 10, white areas represent channels (frequency bands) and polarizations which satisfy the condition that the interference signal level be equal to or less than the threshold value.

Hence in this invention, the reader/writer uses a polarization other than that of a white area in FIG. 10 (in FIG. 10, polarizations 2 and n) at the time of transmission of a command signal, and when receiving the response signal from the tag, uses the polarization 2 or the polarization n.

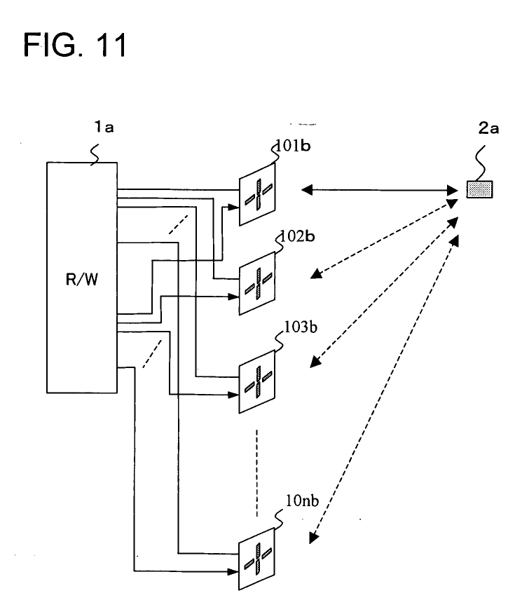

In the above explanation, a configuration was shown in which the reader/writer has one antenna 1b, and the polarization direction of the antenna is switched; but application of this invention is not limited to such a configuration. That is, as shown in FIG. 11, a configuration can also be used in which a plurality of antenna elements 101b to 10nb, each set to a specific polarization direction, are connected to the reader/writer main unit 1a, and switching control is executed so as to activate a specific antenna corresponding to the polarization to be set by the reader/writer main unit 1a.

Further, in FIG. 11 if a mode is employed in which the polarization direction can be controlled as shown in FIG. 5 or FIG. 6 for each of the plurality of antenna elements 101b to 10nb, then searches for channels enabling communication can be performed freely and easily with fewer antennas.

FIG. 12 is another embodiment of the invention. In this configuration, processing is performed to switch the antenna polarization each time for command transmission (step S8) and response signal reception (step S9), as shown in FIG. 8 when using the embodiment of FIG. 5 and FIG. 6.

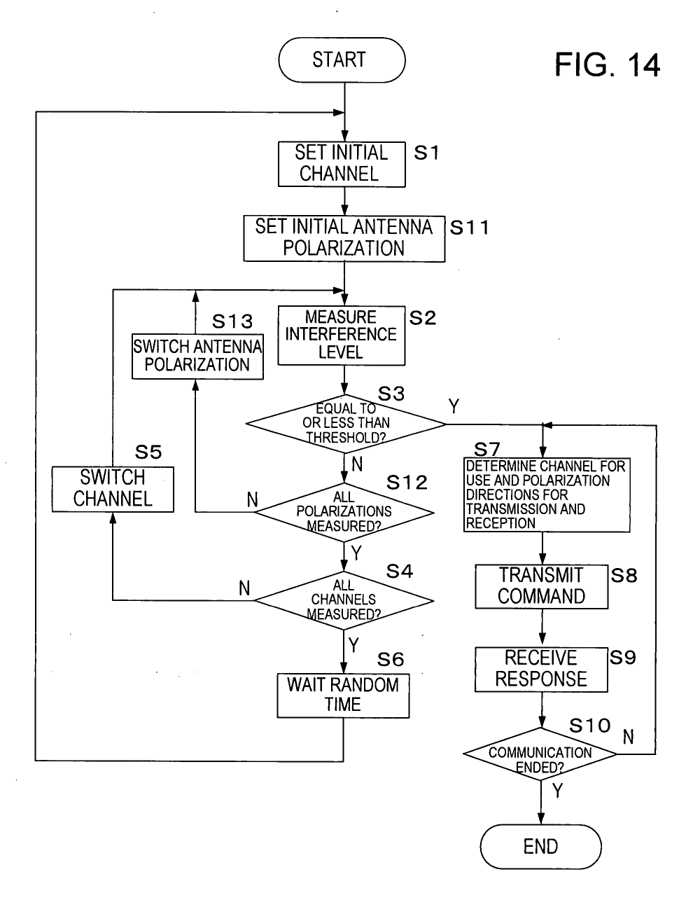

In contrast, in the embodiment of FIG. 12 antenna polarization switching is not performed at the time of command transmission or response signal reception; in this configuration, transmission/reception switching is performed solely through signal processing, as is clear from the flow of operation shown in FIG. 14 in contrast to FIG. 12.

In FIG. 12, as a characteristic, the antenna element 10 comprises horizontal and vertical dipole antennas 10a and 10b. The polarization direction control portion 20 has a switch control portion 11, a transmission/reception switching portion 200 having switches SW1 to SW4, and a bidirectional coupler 201.

The bidirectional coupler 201 has functions to pass signals in both directions between terminals a and b, and to pass signals in both directions between terminals c and d. Hence the switch control portion 11 controls the switches SW1 to SW4 of the transmission/reception switching portion 200 based on polarization switching signals from the reader/writer main unit 1a, according to the characteristics of this bidirectional coupler 201.

Control is executed as follows when command signals are transmitted with horizontal polarization using the horizontal dipole antenna 10a and response signals with vertical polarization are received using the vertical dipole antenna 10b.

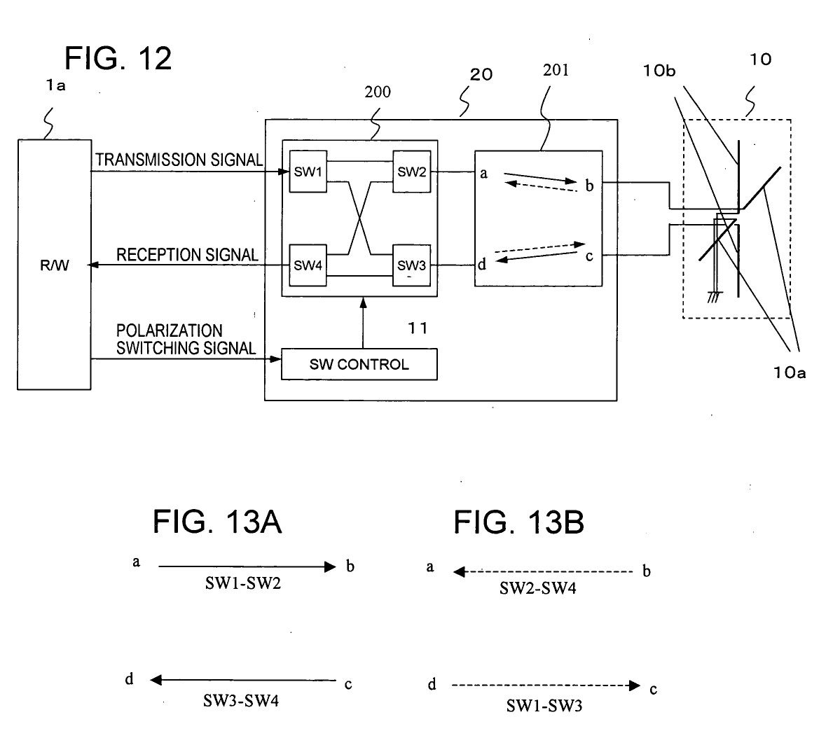

FIG. 13 explains the flow of signals between terminals in the bidirectional coupler 201 and the relation of the switches SW1 to SW4. In accordance with polarization switching signals from the reader/writer main unit 1a, the switch control portion 11 controls the switches SW1 to SW4 so as to input transmission signals to the terminal a of the bidirectional coupler 201 via switches SW1 and SW2 of the transmission/reception switching portion 200, and on the other hand, to input reception signals which is input to the terminal c of the bidirectional coupler 201 and output to terminal d, to the reader/writer main unit 1a via switches SW3 and SW4 (see FIG. 13A).

When the vertical dipole antenna 10b is used to transmit command signals with vertical polarization and the horizontal dipole antenna 10a is used to receive response signals with horizontal polarization, control is executed as follows.

Switches SW1 and SW3 are controlled so that transmission signals are input via switches SW1 and SW3 to the terminal d of the bidirectional coupler 201, and so the transmission signals are output to terminal c and supplied to the vertical dipole antenna 10b. On the other hand, signals received by the horizontal dipole antenna 10a are input to terminal b of the bidirectional coupler 201 and output to terminal a. Hence switches SW2 and SW4 are controlled such that received signals pass through switches SW2 and SW4 and are input to the reader/writer main unit 1a (see FIG. 13B).

FIG. 14 shows the flow of operation corresponding to the embodiment of FIG. 12; similarly to the flow of operation shown above in FIG. 8, in step S7 the channels used and polarization directions for transmission and reception are determined. In the embodiment of FIG. 12, command transmission (step S8) and response reception (step S9) are performed without performing polarization control of the antenna element 10 when the transmission and reception polarization directions are determined. However, at this time, switches SW1 to SW4 of the transmission/reception switching portion 200 are controlled as shown in FIG. 13.

### INDUSTRIAL APPLICABILITY

As explained above, whereas in methods of the prior art searches are only performed for usable channels at a fixed polarization, in this method, by receiving response signals from the tag in a polarization direction at which the [interference signal] level detected as the search result is equal to or less than a threshold, and by performing command signal transmission in a polarization direction different from the polarization direction at which the interference signal level is equal to or less than the threshold, the effect of interference between reader/writers can be reduced. Hence the industrial contribution of this invention is substantial.

Annexes:

1. An RFID system, comprising:

a reader/writer, which has a reader/writer main unit and a polarization-switchable antenna, and which transmits a continuous carrier wave; and

a tag, which modulates the continuous carrier wave with tag information and returns a response signal to the reader/writer;

wherein the reader/writer main unit judges the level of a received interference signal and determines a polarization direction for which the level of the interference signal is equal to or less than a threshold;

a command signal is transmitted to the tag with a polarization direction different from the determined polarization direction; and

a response signal from the tag to the command signal is received with the determined polarization direction.

2. The RFID system according to annex 1, wherein the polarization-switchable antenna can be switched between right-circular polarization and left-circular polarization.

3. The RFID system according to annex 1, wherein the polarization-switchable antenna can be switched between horizontal polarization and vertical polarization.

4. The RFID system according to annex 1, wherein the reader/writer main unit judges the levels of interference signals received in each of a plurality of channels, and determines a polarization direction for which the interference signal level is equal to or less than the threshold.

5. An RFID system, comprising:

a reader/writer, which has a reader/writer main unit and a plurality of antennas each having a specific polarization, and which transmits a continuous carrier wave; and

a tag, which modulates the continuous carrier wave with tag information and returns a response signal to the reader/writer;

wherein the reader/writer main unit judges the level of received interference signals for each of the plurality of antennas and determines an antenna with polarization at which the judged level of the interference signal is equal to or less than a threshold;

a command signal is transmitted from an antenna with a polarization other than the determined polarization; and

a response signal from the tag to the command signal is received by the antenna with the determined polarization.

6. The RFID system according to annex 5, wherein the reader/writer main unit judges the levels of interference signals received in each of a plurality of channels, and determines an antenna with polarization at which the interference signal level is equal to or less than the threshold.

7. The RFID system according to annex 4 or annex 6, wherein the channels are bands resulting from division into a plurality of frequency bands.

8. The RFID system according to any one of annexes 1 through 7, wherein the tag comprises a patch antenna, and an LSI having an interface portion connected in parallel with the patch antenna and having a capacitance component which resonates with an inductance component of the patch antenna.

9. An RFID communication control method, in an RFID system comprising a reader/writer which has a reader/writer main unit and a polarization-switchable antenna and transmits a continuous carrier wave, and a tag which modulates the continuous carrier wave with tag information and returns a response signal to the reader/writer,

the RFID communication control method comprising the steps of:

measuring an interference signal level for a specific channel sequentially for all switchable polarizations of the antenna;

when the measured interference signal level is equal to or greater than a threshold, switching a specific channel to another channel and measuring the interference signal level;

determining a channel and polarization direction for which the measured interference signal level does not exceed the threshold are determined;

sending a command signal to the tag with a polarization direction other than the determined polarization direction; and

receiving a response signal to the command signal at the determined channel and polarization direction.

10. The RFID communication control method according to annex 9, wherein the polarization-switchable antenna can be switched between right-circular polarization and left-circular polarization.

11. The RFID communication control method according to annex 9, wherein the polarization-switchable antenna can be switched between horizontal polarization and vertical polarization.

12. An RFID communication control method, in an RFID system having a reader/writer which has a reader/writer main unit and a plurality of antennas each set to different polarization directions and which transmits a continuous carrier wave, and a tag which modulates the continuous carrier wave with tag information and returns a response signal to the reader/writer,

the RFID communication control method comprising the steps of:

measuring an interference signal level for a specific channel sequentially for all switchable polarizations of the antenna;

when the measured interference signal level is equal to or greater than a threshold, switching a specific channel to another channel and measuring the interference signal level;

determining a channel and polarization direction for which the measured interference signal level does not exceed the threshold are determined;

sending a command signal to the tag with a polarization direction other than the determined polarization-direction; and

receiving a response signal to the command signal at the determined channel and polarization direction.

13. The RFID communication control method system according to any one of annex 9 to annex 12, wherein the channels are bands resulting from division into a plurality of frequency bands.

14. The RFID communication control method according to any one of annex 9 to annex 12, wherein the tag comprises a patch antenna, and an LSI having an interface portion connected in parallel with the patch antenna and which has a capacitance component which resonates with an inductance component of the patch antenna.

15. A reader/writer, comprising a reader/writer main unit and a polarization-switchable antenna, in an RFID system in which a continuous carrier wave is transmitted toward tags,

wherein the level of a received interference signal is judged, and a channel and polarization direction for the antenna for which the level of the interference signal is equal to or less than a threshold are determined;

a command signal is sent to the tag with a polarization direction other than the determined polarization direction; and

a response signal to the command signal, generated by modulating the continuous carrier wave with tag information and returned from the tag, is received with the determined polarization direction and in the determined channel.

16. The reader/writer according to annex 15, wherein the polarization-switchable antenna can be switched between right-circular polarization and left-circular polarization.

17. The reader/writer according to annex 15, wherein the polarization-switchable antenna can be switched between horizontal polarization and vertical polarization.

18. A reader/writer, comprising a reader/writer main unit and a plurality of antennas each having a specific polarization, in an RFID system in which a continuous carrier wave is transmitted toward tags,

wherein the reader/writer main unit judges the levels of interference signals received by each of the plurality of antennas in a plurality of channels, and determines a channel and antenna for which the judged level of the interference signal is equal to or less than a threshold;

a command signal is sent to the tag by an antenna other than the determined antenna; and

a response signal, generated by modulating the continuous carrier wave with tag information and returned from the tag, is received by the determined antenna and in the determined channel.

19. A reader/writer, comprising a reader/writer main unit and two dipole antennas having horizontal polarization and vertical polarization respectively, in an RFID system in which a continuous carrier wave is transmitted toward tags,

further comprising a transmission/reception switch,

wherein the reader/writer main unit judges the levels of interference signals received in a plurality of channels with the horizontal polarization and with the vertical polarization, and determines a channel and either horizontal or vertical polarization at which the judged level of the interference signal is equal to or less than a threshold; and

in accordance with a switching signal based on determination by the reader/writer main unit, the transmission/reception switch performs switching control so as to output a command signal output from the reader/writer main unit to the dipole antenna not corresponding to the determined horizontal or vertical polarization, among the two dipole antennas, and so as to input to the reader/writer main unit a response signal returned from the tag and received by the dipole antenna corresponding to the determined horizontal or vertical polarization.

What is claimed is:

1. An RFID system, comprising:
a reader/writer, which has a reader/writer main unit and a polarization-switchable antenna, and which transmits a continuous carrier wave; and
a tag, which modulates the continuous carrier wave with tag information and returns a response signal to the reader/writer;
wherein the reader/writer main unit judges the level of a received interference signal and determines a polarization direction for which the level of the interference signal is equal to or less than a threshold;
a command signal is transmitted to the tag with a polarization direction different from the determined polarization direction; and
a response signal from the tag to the command signal is received with the determined polarization direction.

2. The RFID system according to claim 1, wherein the polarization-switchable antenna can be switched between right-circular polarization and left-circular polarization.

3. The RFID system according to claim 1, wherein the polarization-switchable antenna can be switched between horizontal polarization and vertical polarization.

4. The RFID system according to claim 1, wherein the reader/writer main unit judges the levels of interference signals received in each of a plurality of channels, and determines a polarization direction for which the interference signal level is equal to or less than the threshold.

5. An RFID system, comprising:
a reader/writer, which has a reader/writer main unit and a plurality of antennas each having a specific polarization, and which transmits a continuous carrier wave; and
a tag, which modulates the continuous carrier wave with tag information and returns a response signal to the reader/writer;
wherein the reader/writer main unit judges the level of received interference signals for each of the plurality of antennas and determines an antenna with polarization at which the judged level of the interference signal is equal to or less than a threshold;
a command signal is transmitted from an antenna with a polarization other than the determined polarization; and
a response signal from the tag to the command signal is received by the antenna with the determined polarization.

6. The RFID system according to claim 5, wherein the reader/writer main unit judges the levels of interference signals received in each of a plurality of channels, and determines an antenna with polarization at which the interference signal level is equal to or less than the threshold.

7. The RFID system according to claim 4, wherein the channels are bands resulting from division into a plurality of frequency bands.

8. The RFID system according to claim 1, wherein the tag comprises a patch antenna, and an LSI having an interface portion connected in parallel with the patch antenna and having a capacitance component which resonates with an inductance component of the patch antenna.

9. An RFID communication control method, in an RFID system having a reader/writer which has a reader/writer main unit and a plurality of antennas each set to different polarization directions and which transmits a continuous carrier wave, and a tag which modulates the continuous carrier wave with tag information and returns a response signal to the reader/writer,
the RFID communication control method comprising the steps of:
measuring an interference signal level for a specific channel sequentially for all switchable polarizations of the antenna;
when the measured interference signal level is equal to or greater than a threshold, switching a specific channel to another channel and measuring the interference signal level;
determining a channel and polarization direction for which the measured interference signal level does not exceed the threshold are determined;
sending a command signal to the tag with a polarization direction other than the determined polarization direction; and
receiving a response signal to the command signal at the determined channel and polarization direction.

10. The RFID communication control method system according to claim 9, wherein the channels are bands resulting from division into a plurality of frequency bands. bands.

11. The RFID communication control method according to claim 9, wherein the tag comprises a patch antenna, and an LSI having an interface portion connected in parallel with the patch antenna and which has a capacitance component which resonates with an inductance component of the patch antenna.
